(19) United States
(12) Patent Application Publication
(10) Pub. No.: US 2023/0153640 A1
(43) Pub. Date: May 18, 2023

(54) Prediction Model Learning Method, Apparatus and System for an Industrial System

(71) Applicant: Siemens Aktiengesellschaft, München (DE)

(72) Inventors: Jing Li, Shanghai (CN); Wei Feng Xu, Shanghai (CN); Ming Li, Shanghai (CN)

(73) Assignee: Siemens Aktiengesellschaft, München (DE)

(21) Appl. No.: 17/916,234

(22) PCT Filed: Mar. 31, 2020
(86) PCT No.: PCT/CN2020/082459

§ 371 Date: Sep. 30, 2022

(51) Int. Cl. G06N 5/022

(52) U.S. Cl. CPC G06N 5/022

(57) ABSTRACT

Various embodiments include prediction model learning methods for industrial systems, including a simulation according to a simulation task on a platform. Some methods include: using statistical metrics to quantify a simulation task to extract features; extracting parameter groups from system modules, adjusting the values of the parameter groups, and triggering a simulation for the industrial system on the simulation platform based on a plurality of parameter groups having different values; recording performance metrics according to the values of the parameter groups after the parameter adjustment; and training data with a machine learning algorithm based on the features of the simulation task, the corresponding parameter groups having different values and the performance metrics, and generating a prediction model.

### CROSS-REFERENCE TO RELATED APPLICATIONS

This application is a U.S. National Stage Application of International Application No. PCT/CN2020/082459 filed Mar. 31, 2020, which designates the United States of America, the contents of which are hereby incorporated by reference in their entirety.

### TECHNICAL FIELD

The present disclosure relates to the industrial automation field. Various embodiments of the teachings herein include prediction model learning methods, apparatus and/or systems for an industrial system with automation.

### BACKGROUND

More and more complicated systems, for example, intelligent robots and automatic driving systems, have been applied in the industrial field. Predicting the performance of those complicated systems allows users to take positive action, for example, change system parameters when it is necessary to meet the performance requirement.

However, it is not easy to predict the performance of complicated systems. One way is to evaluate the system performance through a simulation. A plurality of scenarios are produced and tests are performed during simulations so as to produce a large amount of simulation results for performing an evaluation. However, it will take a lot of simulation execution time to explore the design space (for example, parameter debugging) of a target system. In addition, it will take man-labor and time to establish and perform simulations in a scenario. Therefore, a typical simulation platform helps to test and evaluate a complicated system, but is not suitable for predicting the system performance online.

Therefore, establishing a prediction model for a complicated industrial system based on real data is a better solution. However, it is very expensive and sometimes impossible to collect real data of all subsystems of a complicated industrial system.

To solve the above-mentioned problem, some solutions use a machine learning method to establish training data for refreshing the manipulator, select a prediction model template from a database and debug data based on refreshed data to optimize the prediction model. However, that solution depends on the analysis of the collected real data, instead of the simulation mechanism. In addition, a prediction template base is required and a template is refined through additional training. The predicted target in that solution is associated with the business, especially the sales volume.

Some solutions evaluate the credibility. The solution provides the complete application of a grey prediction model to qualitatively and quantitatively discover the inherent law of a complicated simulation system from limited test data so as to improve the credibility evaluation of the complicated system. The effect of that solution is only limited to the credibility, instead of the performance metrics.

In order to control the parameter debugging mechanism, the parameter optimization may be controlled based on simulations. The model error problem is solved and a control parameter adjustment with a higher accuracy can be identified. However, that solution is not for a complicated system, nor based on simulations. In addition, that solution is limited to only servo motors and parameter debugging controllers.

Some solutions use a neural network robot trained in a simulation environment. The neural network robot collects comprehensive presentation statistics (bin) from an algorithm supervisor in a pybullet simulator, and then learns the policies of the neural network through the comprehensive data acquired from the simulator. The neural network robot controller is also trained based on the trajectory data acquired from the simulator. However, that solution is useful for an intelligent robot system and collected simulation data. The key point of the solution lies in training a robot controller, instead of enhancing the simulator for a complicated system and the simulator to obtain a prediction model generator.

### SUMMARY

Some of the embodiments of the teachings herein include a prediction model learning method for an industrial system, wherein a simulation is performed for the industrial system according to a simulation task on a platform, and the prediction model learning method for an industrial system comprises steps of: S1, using statistical metrics to quantify a simulation task of the industrial system so as to extract features of the simulation task; S2, extracting parameter groups from system modules of the industrial system which performs a simulation, adjusting the values of the parameter groups, and triggering a simulation for the industrial system on the simulation platform based on a plurality of parameter groups having different values; S3, recording performance metrics according to the values of the parameter groups after the parameter adjustment; and S4, training data by use of a machine learning algorithm based on the features of the simulation task, the corresponding parameter groups having different values and the performance metrics, and generating a prediction model.

In some embodiments, Step S2 comprises steps of: S21, extracting parameter groups from system modules of the industrial system which performs a simulation, and marking adjustable parameter groups; S22, adjusting the values of the adjustable parameter groups according to the corresponding adjustable range of each adjustable parameter group, and triggering a simulation for the industrial system on the simulation platform based on a plurality of parameter groups having different values; and S23, synchronizing and recording the combination and values of the parameter groups after the parameter adjustment.

In some embodiments, Step S3 comprises steps of: S31, recording performance metrics according to the values of the parameter groups after the parameter adjustment; and S32, recording the values of the performance metrics based on the recorded performance metrics and the simulation result which correspond to each other.

In some embodiments, the performance metrics are key performance indexes or are determined based on the customer requirements.

In some embodiments, after step S4, the method further comprises a step of querying the prediction model based on the features of the input simulation task and the values of the parameter groups to obtain the values of the performance metrics.

In some embodiments, the industrial system is a context-aware robot, wherein the features of the simulation task include a plurality of metrics of a red-green-blue-depth (RGBD) image, and the metrics include one or more of the following: image resolution; target scale in image; and object mean.

In some embodiments, the context-aware robot is a grasping robot and the system modules thereof include: a vision module, configured to process an input RGBD image, a path planning module, configured to figure out the path along which the manipulator moves to a grasping point according to the grasping point obtained through image recognition, and an action control module, configured to control the movement of the manipulator according to the path planned by the path planning module.

As another example, some embodiments include a prediction model learning system for an industrial system, comprising: a processor, and a memory coupled with the processor, the memory having instructions stored therein, the instructions allowing the prediction model learning system for an industrial system to perform actions when executed by the processor, and the actions including: S1, using statistical metrics to quantify a simulation task of the industrial system so as to extract features of the simulation task; S2, extracting parameter groups from system modules of the industrial system which performs a simulation, adjusting the values of the parameter groups, and triggering a simulation for the industrial system on the simulation platform based on a plurality of parameter groups having different values; S3, recording performance metrics according to the values of the parameter groups after the parameter adjustment; and S4, training data by use of a machine learning algorithm based on the features of the simulation task, the corresponding parameter groups having different values and the performance metrics, and generating a prediction model.

In some embodiments, action S2 further comprises: S21, extracting parameter groups from system modules of the industrial system which performs a simulation, and marking adjustable parameter groups; S22, adjusting the values of the adjustable parameter groups according to the corresponding adjustable range of each adjustable parameter group, and triggering a simulation for the industrial system on the simulation platform based on a plurality of parameter groups having different values; and S23, synchronizing and recording the combination and values of the parameter groups after the parameter adjustment.

In some embodiments, action S3 further comprises: S31, recording performance metrics according to the values of the parameter groups after the parameter adjustment; and S32, recording the values of the performance metrics based on the recorded performance metrics and the simulation result which correspond to each other.

In some embodiments, after action S4, the actions further include: querying the prediction model based on the features of the input simulation task and the values of the parameter groups to obtain the values of the performance metrics.

As another example, some embodiments include a computer-readable medium, computer-executable instructions being stored in the computer-readable medium, and the computer-readable instructions allowing at least one processor to execute one or more of the methods described herein.

### BRIEF DESCRIPTION OF THE DRAWINGS

FIG. 1 shows the structure of the prediction model learning system for an industrial system incorporating teachings of the present disclosure;

FIG. 2 shows a scenario where a grasping robot grasps parts from a box incorporating teachings of the present disclosure;

FIG. 3 shows the structure of the parameter adjustment management unit of the prediction model learning system for an industrial system incorporating teachings of the present disclosure;

FIG. 4 is a logic diagram of parameter adjustments of the prediction model learning mechanism for an industrial system incorporating teachings of the present disclosure;

FIG. 5 shows the structure of the performance recording unit of the prediction model learning system for an industrial system incorporating teachings of the present disclosure; and

FIG. 6 is a schematic diagram of the decision tree C5.0 of the prediction model learning mechanism for an industrial system incorporating teachings of the present disclosure.

### DETAILED DESCRIPTION

In some embodiments of the present disclosure, there is a prediction model learning method, wherein a simulation is performed for the industrial system according to a simulation task on a platform. In some embodiments, the prediction model learning method for an industrial system comprises the following steps: S1, using statistical metrics to quantify a simulation task of the industrial system so as to extract features of the simulation task; S2, extracting parameter groups from system modules of the industrial system which performs a simulation, adjusting the values of the parameter groups, and triggering a simulation for the industrial system on the simulation platform based on a plurality of parameter groups having different values; S3, recording performance metrics according to the values of the parameter groups after the parameter adjustment; and S4, training data by use of a machine learning algorithm based on the features of the simulation task, the corresponding parameter groups having different values and the performance metrics, and generating a prediction model.

In some embodiments, step S2 comprises the following steps: S21, extracting parameter groups from system modules of the industrial system which performs a simulation, and marking adjustable parameter groups; S22, adjusting the values of the adjustable parameter groups according to the corresponding adjustable range of each adjustable parameter group, and triggering a simulation for the industrial system on the simulation platform based on a plurality of parameter groups having different values; and S23, synchronizing and recording the combination and values of the parameter groups after the parameter adjustment.

In some embodiments, the step S3 comprises the following steps: S31, recording performance metrics according to the values of the parameter groups after the parameter adjustment; and S32, recording the values of the performance metrics based on the recorded performance metrics and the simulation result which correspond to each other.

In some embodiments, the performance metrics are key performance indexes or are determined based on the customer requirements.

In some embodiments, after step S4, the method further comprises the following step querying the prediction model based on the features of the input simulation task and the values of the parameter groups to obtain the values of the performance metrics.

In some embodiments, the industrial system is a context-aware robot, wherein the features of the simulation task include a plurality of metrics of a red-green-blue-depth (RGBD) image, and the metrics include one or more of the following: image resolution, target scale in image, and object mean.

In some embodiments, the context-aware robot is a grasping robot and the system modules thereof include: a vision module, configured to process an input RGBD image, a path planning module, configured to figure out the path along which the manipulator moves to a grasping point according to the grasping point obtained through image recognition, and an action control module, configured to control the movement of the manipulator according to the path planned by the path planning module.

In some embodiments, there is a prediction model learning apparatus for an industrial system, wherein a simulation is performed for the industrial system according to a simulation task on a platform. In some embodiments, the prediction model learning apparatus for an industrial system comprises: a task feature management unit, configured to use statistical metrics to quantify a simulation task of the industrial system so as to extract features of the simulation task, a parameter adjustment management unit, configured to extract parameter groups from system modules of the industrial system which performs a simulation, adjust the values of the parameter groups, and trigger a simulation for the industrial system on the simulation platform based on a plurality of parameter groups having different values, a performance recording unit, configured to record performance metrics according to the values of the parameter groups after the parameter adjustment, a training data management unit, configured to train data by use of a machine learning algorithm based on the features of the simulation task, the corresponding parameter groups having different values and the performance metrics, and a learning management unit, configured to generate a prediction model.

In some embodiments, the parameter adjustment management unit further comprises a parameter feature group recording subunit, configured to extract parameter groups from system modules of the industrial system which performs a simulation, and mark adjustable parameter groups, a parameter adjustment subunit, configured to adjust the values of the adjustable parameter groups according to the corresponding adjustable range of each adjustable parameter group, and trigger a simulation for the industrial system on the simulation platform based on a plurality of parameter groups having different values; and a parameter recording subunit, configured to synchronize and record the combination and values of the parameter groups after the parameter adjustment.

In some embodiments, the performance recording unit further comprises a performance registration sub-unit, configured to record performance metrics according to the values of the parameter groups after the parameter adjustment, and a performance recording subunit, configured to record the values of the performance metrics based on the recorded performance metrics and the simulation result which correspond to each other.

In some embodiments, the performance metrics are key performance indexes or are determined based on the customer requirements.

In some embodiments, the learning management unit is configured to query the prediction model based on the features of the input simulation task and the values of the parameter groups to obtain the values of the performance metrics.

In some embodiments, there is a prediction model learning system for an industrial system comprising a processor and a memory coupled with the processor, the memory has instructions stored therein, the instructions allow the prediction model learning system for an industrial system to perform actions when executed by the processor, and the actions include: S1, using statistical metrics to quantify a simulation task of the industrial system so as to extract features of the simulation task; S2, extracting parameter groups from system modules of the industrial system which performs a simulation, adjusting the values of the parameter groups, and triggering a simulation for the industrial system on the simulation platform based on a plurality of parameter groups having different values; S3, recording performance metrics according to the values of the parameter groups after the parameter adjustment; and S4, training data by use of a machine learning algorithm based on the features of the simulation task, the corresponding parameter groups having different values and the performance metrics, and generating a prediction model.

In some embodiments, the action S2 comprises: S21, extracting parameter groups from system modules of the industrial system which performs a simulation, and marking adjustable parameter groups; S22, adjusting the values of the adjustable parameter groups according to the corresponding adjustable range of each adjustable parameter group, and triggering a simulation for the industrial system on the simulation platform based on a plurality of parameter groups having different values; and S23, synchronizing and recording the combination and values of the parameter groups after the parameter adjustment.

In some embodiments, the action S3 comprises: S31, recording performance metrics according to the values of the parameter groups after the parameter adjustment; and S32, recording the values of the performance metrics based on the recorded performance metrics and the simulation result which correspond to each other.

In some embodiments, the actions after action S4 include querying the prediction model based on the features of the input simulation task and the values of the parameter groups to obtain the values of the performance metrics.

In some embodiments, there is a computer program product tangibly stored in a computer-readable medium and comprises computer-executable instructions, and the computer-executable instructions allow at least one processor to execute one or more of the methods described herein.

In some embodiments, there is a computer-readable medium storing computer-executable instructions allowing at least one processor to execute one or more of the methods described herein.

In some embodiments, the data in the simulation task is used to train and build a prediction model. The step of adjusting parameters is a systematic and automatic step, allowing a simulation to produce a large amount of various parameters for data training. Parameter adjustments are often manually completed in the prior art, however. Therefore, those system parameters can be structurally explored and tested, avoiding incomplete considerations in manual parameter adjustment mode.

By use of the teachings of the present disclosure, simulation data can be converted into an online prediction model, which can direct a user to dynamically and more efficiently select a parameter combination and values for a complicated system. When a simulation is performed for an industrial system, these embodiments may simultaneously help a customer to establish an online prediction system. The present disclosure allows industrial customers to online predict the performance of their systems and dynamically adjust parameters.

The following will describe specific embodiments of the present disclosure in combination with the drawings. In some embodiments, an extension of the prior simulation platform can automatically search parameter groups of a complicated system which needs to be simulated, and record major simulation data to learn a latent prediction model for a target industrial system. During a simulation, the methods may record data of interest for each system module, builds a scenario and a feature group of adjusted parameters, and finally applies equipment for sampling to generate a prediction model for a simulated system. By using the prediction model, a user can quickly predict the performance of a complicated system based on a specific scenario and parameters and optimize the system through automatic selections of system parameters, wherein the prediction model is utilized to meet the performance requirement during the automatic selection of system parameters.

When the performance of a target system is simulated, the teachings of the present disclosure can help customers to establish an online prediction system for their complicated systems. Wherein, the target system includes an intelligent robot system, a manufacturing unit or a production line. This can allow customers to online predict the performance of their systems and automatically adjust parameters. In some embodiments, the methods can be applied to a large number of neighbors, especially complicated industrial systems, including industrial context-aware manufacturing system, for example, autonomous equipment, workstations and workshops. In some embodiments, the methods are applicable to context-aware devices, for example, the fields of automatic driving, intelligent robots and drones.

In some embodiments, the methods include a mechanism for automatically learning a prediction model from a simulation and the present invention is an extension of the function of the simulation platform into online model building. In some embodiments, the methods can be easily integrated into a prior simulator.

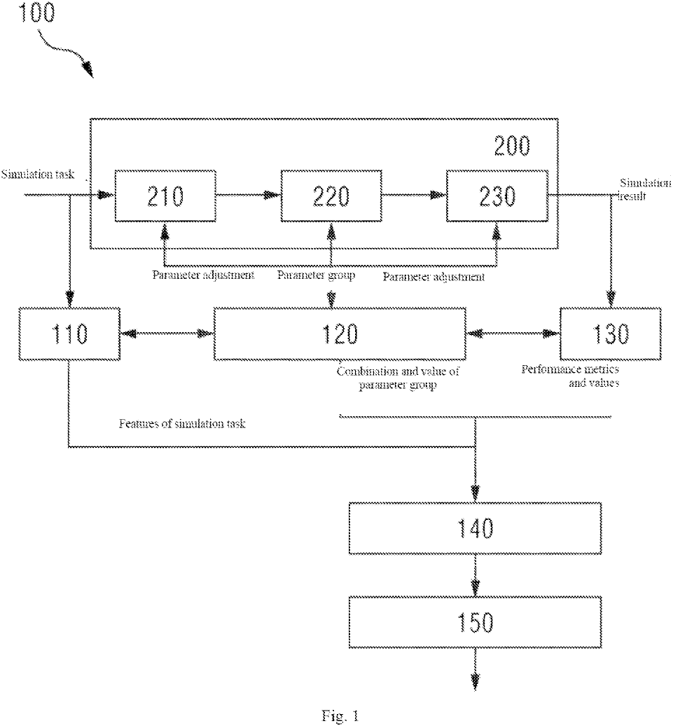

FIG. 1 shows the structure of the prediction model learning system for an industrial system incorporating teachings of the present disclosure. Specifically, the prediction model learning system 100 for an industrial system comprises a task feature management unit 110, a parameter adjustment management unit 120, a performance recording unit 130, a training data management unit 140 and a learning management unit 150. The prediction model learning system 100 for an industrial system is a function extension of the prior simulation platform 200. A simulation task is input into the simulation platform 200 and a simulation result is output.

The teachings of the present disclosure are further described in combination with an embodiment where a simulation is performed for a grasping robot serving as an industrial system. In some embodiments, there is a prediction model learning method for an industrial system and the method comprises the following steps:

Step S1 is first performed. The task feature management unit 110 uses statistical metrics to quantify the simulation task of the industrial system so as to extract features of the simulation task. Specifically, the task feature management unit 110 is configured to manage and load the features of the simulation task, namely, use statistical metrics to quantify the features of the input simulation task and provide feature data of the simulation task for the training data management unit 140 after the simulation.

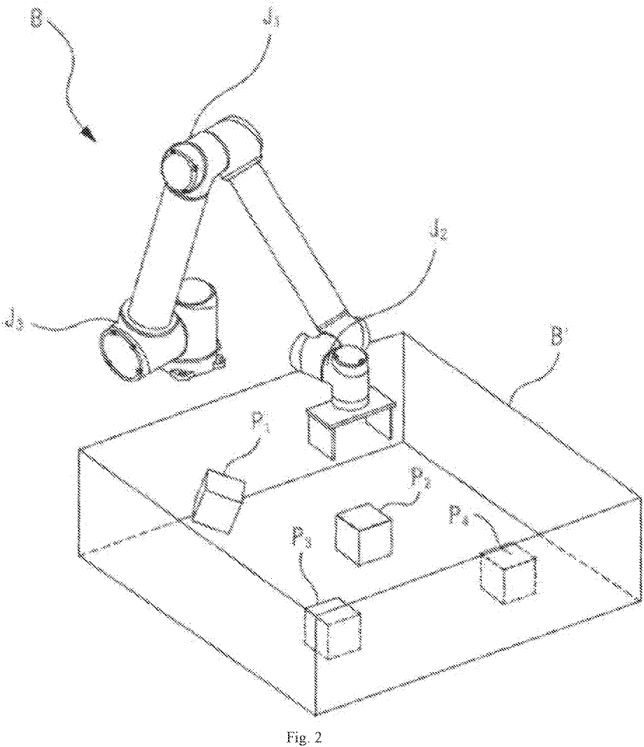

As shown in FIG. 2, what needs to simulated is the process that an industrial system, which is a grasping robot, grasps a plurality of parts from a box B′. The grasping robot B moves a first joint j₁, a second joint j₂ and a third joint j₃ according to a planned path so as to grasp a plurality of parts from the box B′ , and the plurality of parts include a first part p₁, a second part p₂ and a third part p₃, for example.

As shown in FIG. 1, the simulation platform 200 simulates the above-mentioned process of the grasping robot B, wherein the simulation platform 200 comprises a plurality of system modules of the grasping robot B, including a vision module 210, a path planning module 220 and an action control module 230. In the present embodiment, an image, especially, an RGBD image, is input into the simulation platform 200. The vision module 210 processes an input RGBD image, the path planning module 220 figures out the path along which the manipulator moves to a grasping point according to the grasping point obtained through image recognition, and the action control module 230 controls the movement of the manipulator according to the path planned by the path planning module 220.

Specifically, image data may be input into the task feature management unit 110 and the simulation task calculated by the task feature management unit is a statistical metric group of image data. The metrics and features can be predefined in the task feature management unit 110 and the task feature management unit can extract the features of a simulation required to be performed in an input simulation task. For example, in the present embodiment, the grasping robot B is a context-aware robot, and the features of the simulation task is a plurality of metrics of a series of RGBD images, wherein one metric is a feature vector I:

I=[image resolution, target scale in image, object mean]

The above-mentioned feature values can be figured out from task data based on each specific simulation execution and stipulated by the simulation platform. The values of the task feature data are synchronized by the parameter adjustment management unit 120 with the metrics and are saved as a part of a training data set later.

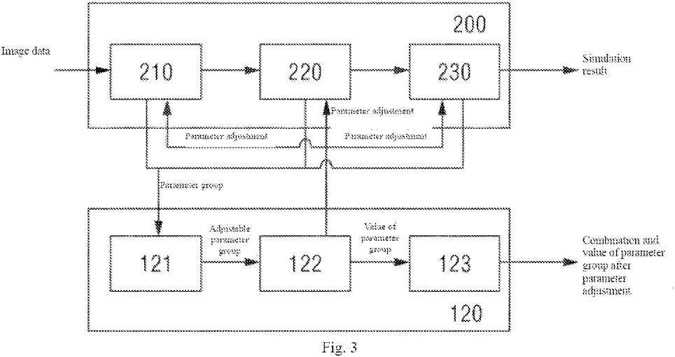

Then step S2 is performed. The parameter adjustment management unit 120 extracts parameter groups from system modules of the industrial system which performs a simulation, adjusts the values of the parameter groups, and triggers a simulation for the industrial system on the simulation platform based on a plurality of parameter groups having different values 200. Step S2 comprises three sub-steps: S21, S22 and S23. As shown in FIG. 3, the parameter adjustment management unit 120 consists of three subunits, which are a parameter feature group recording subunit 121, a parameter adjustment subunit 122 and a parameter recording subunit 123, respectively. In addition, the parameter adjustment management unit 120 is further configured to automatically record parameters for a plurality of system modules and the parameter adjustment management unit can systematically produce simulation data for the learning management unit 150.

In sub-step S21, the feature group recording subunit 121 extracts parameter groups from system modules of the industrial system which performs a simulation, and marks adjustable parameter groups. The feature group recording subunit 121 sends the adjustable parameter groups to the parameter adjustment subunit 122.

In some embodiments, the parameter feature group recording subunit 121 collects adjustable parameter groups from each system module, namely, collects adjustable parameter groups from the vision module 210, the path planning module 220 and the action control module 230. The above-mentioned parameters may be marked with “adjustable” . Then, those adjustable parameters and the adjustable ranges are also sent to the parameter adjustment subunit 122 of the parameter adjustment management unit 120 for a subsequent analysis. The parameter feature group recording subunit 121 outputs parameter feature values.

In the present embodiment, among the input parameter groups, the adjustable parameter groups marked by the parameter feature group recording subunit 121 include:

$$\text{Perception} = \left[\begin{matrix}\overline{{x}_{1}} \\ \overline{{x}_{2}} \\ \overline{{x}_{3}}\end{matrix}\right] = \left[\begin{matrix}x {}_{2 m i n} & {x}_{2 m a x} \\ {x}_{2 m i n} & {x}_{2 m a x} \\ {x}_{3 m i n} & {x}_{3 m a x}\end{matrix}\right] ;$$

$$\text{Path} \text{Planner} = \left[\begin{matrix}\overline{{y}_{2}} \\ \overline{{y}_{2}}\end{matrix}\right] = \left[\begin{matrix}{y}_{11} & {y}_{12} & {y}_{13} \\ {y}_{21} & {y}_{22} & {y}_{23}\end{matrix}\right] ;$$

$$\text{Motion} \text{Controller} = \left[{}_{\overline{{Z}_{2}}}^{\overline{{Z}_{1}}}\right] = \left[\begin{matrix}{z}_{1 m i n} & {z}_{1 m a x} \\ {z}_{2 m i n} & {z}_{2 m a x}\end{matrix}\right] ,$$

wherein, Perception is an adjustable parameter group extracted from the vision module 210, Path Planner is an adjustable parameter group extracted from the path planning module 220, and Motion Controller is an adjustable parameter group extracted from the action control module 230. Wherein, the adjustable parameter group Perception extracted from the vision module 210 comprises x₁, x₂ and x₃, and x₁, x₂ and x₃ have a value range from x₁ₘᵢₙ to x₁ₘₐₓ, a value range from X₂ₘᵢₙ to x₂ₘₐₓ, and a value range from X₃ₘᵢₙ to x₃ₘₐₓ, respectively. For example, the LINEMOD algorithm is used for the parameter feature group recording subunit 121, x₃ is the similarity of templates, x₂ is the non-maximum suppression, and x₃ is the contrast ratio. The adjustable parameter group Path Planner extracted from the path planning module 220 comprises y₃ and y₂, and y₃ and y₂ have discrete values defined as y₁₁, Y₁₂ and Y₁₃, and Y₂₁, Y₂₂ and Y₂₃, respectively. Wherein, Y₁ and Y₂ are parameters in terms of route selection and comprise a start point and path points. In addition, the adjustable parameter group Motion Controller extracted from the action control module 230 comprises z₁ and z₂, which represent the endpoint velocity and the acceleration of the grasping robot B, respectively, and z₁ and z₂ may be continuous variables or discrete values.

In sub-step S22, the parameter adjustment subunit 122 adjusts the values of the adjustable parameter groups according to the corresponding adjustable range of each adjustable parameter group, and trigger a simulation for the industrial system on the simulation platform based on a plurality of parameter groups having different values 200. The parameter adjustment subunit 122 sends the values of the parameter groups to the parameter recording subunit 123. The parameter adjustment subunit 122 is configured to systematically and automatically select parameter feature values from a parameter feature group, then adjust parameters, send the parameters after the parameter adjustments to the simulation platform 200, and trigger a simulation for the target industrial system to perform corresponding tests for the selected features in the simulation. Based on application requirements and customer requirements, a plurality of policies are applied to a parameter adjustment. One policy is that a combination of all possible values in the feature group is used for a parameter adjustment, and another policy is that variable values are selected according to a specific distribution, for example, normal distribution.

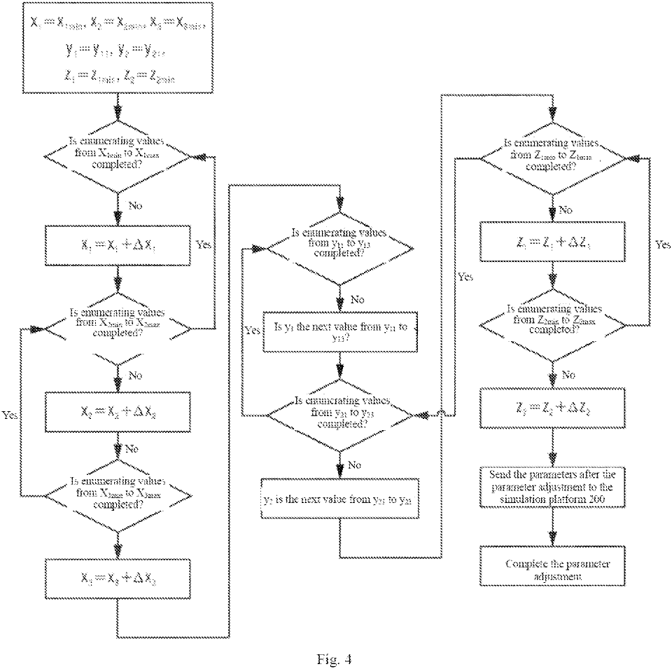

FIG. 4 is a logic diagram of parameter adjustments of the prediction model learning mechanism for an industrial system incorporating teachings of the present disclosure. As shown in FIG. 4, the logic sequence of parameter adjustments is basically as follows: first adjust the parameter x, then adjust the parameter y, and finally adjust the parameter z. Specifically, the initial states of the above-mentioned parameters include:

$${\text{X}}_{\text{1}} = {\text{X}}_{\text{1min}} , {\text{X}}_{2} = {\text{X}}_{\text{2min}} , {\text{X}}_{\text{3}} = {\text{X}}_{\text{3min}} ,$$

$${Y}_{1} = {Y}_{11} , {Y}_{2} = {Y}_{21} ,$$

$${\text{Z}}_{\text{1}} = {\text{Z}}_{\text{1min}} , {\text{Z}}_{\text{2}} = {\text{Z}}_{\text{2min}} ,$$

Then determine whether enumerating values from X₁ₘᵢₙ to X₁ₘₐₓ is completed. If no, continue to enumerate values according to X₁ = X₁ + Δx₁. Determine whether enumerating values from x₂ₘᵢₙ to X₂ₘₐₓ is completed. If yes, go back to the previous step, and otherwise continue to enumerate values according to x₂ = x₂+Δx₂. Then determine whether enumerating values from x₃ₘᵢₙ to X₃ₘₐₓ is completed. If yes, go back to the previous step, and otherwise, continue to enumerate values according to x₃ = x₃ + Δx₃.

Then determine whether enumerating values from Y₁₁ to Y₁₃ is completed. If no, set Y₁ to the next value from Y₁₁ to Y₁₃, then determine whether enumerating values from Y₂₁ to Y₂₃ is completed. If yes, go back to the previous step, and otherwise set Y₂ to the next value from Y₂₃ to Y₂₃.

Finally determine whether enumerating values from Z₁ₘᵢₙ to Z₁ₘₐₓ is completed. If no, continue to enumerate values according to z₁ = Z₁ + Δz₁, and if yes, go back to the step of determining whether enumerating values from Y₂₁ to Y₂₃ is completed. Then determine whether enumerating values from z₂ₘᵢₙ to Z₂ₘₐₓ is completed. If no, continue to enumerate values according to z₂ = z₂ + Δz₂, and if yes, go back to the previous step. Then, send the parameters after the adjustment to the simulation platform 200 to complete the parameter adjustment.

Therefore, the parameters x, y and z after the completion of parameter adjustments are sent to the vision module 210, the path planning module 220 and the action control module 230, respectively.

In sub-step S23, the parameter recording subunit 123 synchronizes and records the combination and values of the parameter groups after the parameter adjustment.

Then step S3 is performed. The performance recording unit 130 records the performance metrics according to the values of the parameter groups after the parameter adjustment, wherein the performance metrics are key performance indexes (KPIs) . Wherein, the performance recording unit 130 and the parameter adjustment management unit 120 cooperate with each other to record the KPIs of the industrial system and keep the KPIs consistent with each value of the parameter feature groups. The performance recording unit 130 further comprises a performance registration subunit 131 and a performance recording subunit 132. Step S3 comprises sub-step S31 and sub-step S32.

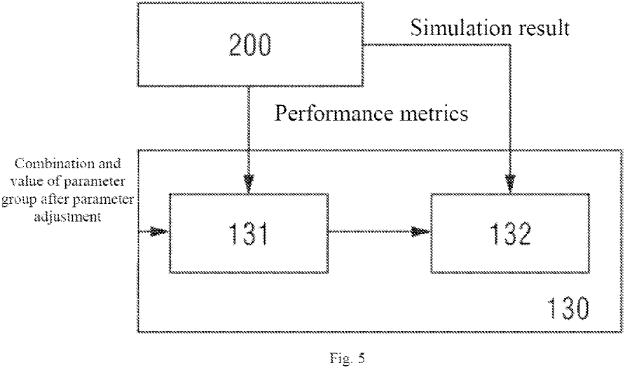

As shown in FIG. 5, the performance recording unit 130 further comprises a performance registration subunit 131 and a performance recording subunit 132.

In sub-step S31, the performance registration subunit 131 records performance metrics according to the values of the parameter groups after the parameter adjustment. The performance registration subunit 131 cooperates with the parameter adjustment management unit 120 to record KPIs according to each value of the performance feature groups. Specifically, the performance registration subunit 131 collects the performance metrics of an industrial system serving as the simulation target, and the performance metrics can be marked in the simulation platform 200. Usually, the performance metrics are related to the KPIs which customers are interested in. A plurality of metrics can be recorded in the performance recording unit 130. For example, in a context-aware robot system, the performance metric of the grasping robot B is alternatively “whether the task of grasping a part (for example, first part p1, second part p2 and third part p3) from a box is successfully completed”. Therefore, the task is recorded as r in the performance registration subunit 131, and it is stipulated that the task is completed when r = 1, and the task fails when r = 0. Another performance metric example is alternatively time t. The time t represents the time it takes a grasping robot B to complete the whole grasping process.

In sub-step S32, the performance recording subunit 132 records the values of the performance metrics based on the recorded performance metrics and the simulation result. Wherein, the values of the performance metrics are associated with the metrics in the parameter adjustment management unit 120. The performance recording subunit needs to cooperate with the parameter adjustment management unit 120 to complete each round of data recording. Wherein, the combination and values of each parameter group correspond to a simulation result, and each simulation result also corresponds to each performance metric. In some embodiments, the performance metrics are key performance indexes or are determined based on the customer requirements.

Then, step S4 is performed to train data by use of a machine learning algorithm based on the features of the simulation task, the corresponding parameter groups having different values and the performance metrics, and generate a prediction model.

Specifically, the training data management unit 140 acquires feature data of the simulation task from the task feature management unit 110, acquires the combination and values of the parameter groups from the parameter adjustment management unit 120, and acquires performance metrics and value data from the performance recording unit 130, respectively, and prepare training data for the learning management unit 150. The training data management unit 140 is further configured to clean data and pre-process data.

In the present embodiment, the input of the training data management unit 140 is:

$$\begin{matrix}\left[\text{Features} \text{of} \text{} \text{simulation} \text{task,} \text{values} \text{of} \text{parameter} \text{groups,} \text{values} \text{of}\right) \\ \text{performance} \left(\text{metrics}\right] = \left[I , {x}_{1} , {x}_{2} , {x}_{3} , {y}_{1} , {y}_{2} , {z}_{1} , {z}_{2} , r , t\right]\end{matrix}$$

wherein, I is the feature of the simulation task of the grasping robot B acquired from the task feature management unit 110, namely, one feature vector of the image data of the grasping robot B. The parameter group value combination comprises x₁, x₂, x₃, y₁, y₂, z₁, z₂ R is a performance metric matrix for different parameter group combinations and values, and r and t are weight vectors of the performance metric R.

Specifically, a simulation result and a performance metric matrix R will be obtained after a simulation is performed based on each parameter group combination and the values. For example, R is determined by two weight vectors r and t, as shown below:

$$\text{R} = {w}_{1} r + {w}_{2} t$$

wherein, W₁ and W₂ are the weights for measuring each performance metric, and the purpose of combining the performance metrics into one metric is to execute a machine algorithm. Therefore, training data comprises:

$$\left[I , {x}_{1} , {x}_{2} , {x}_{3} , {y}_{2} , {y}_{2} , {z}_{2} , {z}_{2} , \text{R}\right]$$

Then, the training data management unit 140 also executes the data cleaning function, for example, cleans noise of data containing missing data or error data. The training data management unit will also apply a specific standard algorithm to preprocess the data to obtain proper training data.

Next, the learning management unit 150 applies different machine learning algorithms to obtain a prediction model, namely, latent rules. Based on the rules of the prediction model, a user can predict the performance of an industrial system and optimize the parameters of the whole industrial system to keep the system more efficient. Those parameters can be searched as many as possible in a simulation.

In some embodiments, prior data mining and the learning algorithm, for example, decision tree C5.0 or artificial neural network (ANN), can be embedded into the learning management unit 150 so that the learning management unit can learn patterns and hinted knowledge from simulation data. Simulation data is well-marked training data, and the learning target is one rule, which can be used to obtain performance metrics for given task features and parameter group values. After obtaining such a rule, a user can quickly predict the system performance for a given scenario and given parameters, or can also utilize the prediction model to online adjust the system parameters to meet the performance requirements.

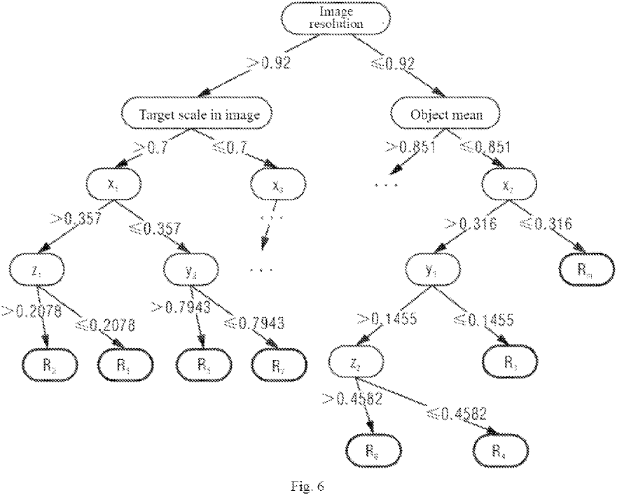

For example, as shown in FIG. 6, we use a decision tree as a learning algorithm to acquire knowledge from the simulation result. By applying the decision tree to training a data set, we can finally obtain the rule knowledge shown in FIG. 6. Wherein, R₁, R₂, ...Rₘ represent different discrete values of R. Based on the learned rule, the performance metric R can directly be obtained from [l, x₁, x₂, x₃, y₁, y₂, z₁, z₂]. Therefore, an acceptable or optimal performance metric R can be obtained by selecting specific values of [l, x₁, x₂, x₃, y₁, y₂, z₁, z₂]. The decision tree is automatically generated by the algorithm. Once data of a customer is entered, the decision tree is automatically used as a prediction model to output a prediction result.

Specifically, the decision tree shown in FIG. 6 is generated by the machine learning algorithm which automatically trains data based on the features of the simulation task, the parameter group having different values and the performance metrics in the previous steps. As shown in FIG. 6, in the grasping robot B, the image resolution of the features of the simulation task is divided into a value range greater than 0.92 and a value range less than or equal to 0.92. When the image resolution is greater than 0.92, the target scale in the image of the features of the simulation task is divided into a value range greater than 0.7 and a value range less than or equal to 0.7. When the image resolution is less than or equal to 0.92, the object mean of the features of the simulation task is divided into a value range greater than 0.851 and a value range less than or equal to 0.851. Further, when the target scale in an image is greater than 0.7, continue to divide X₁ into a value range greater than 0.357 and a value range less than or equal to 0.357, and when the target scale in an image is less than or equal to 0.7, continue to determine X₃. When X₁ is greater than 0.357, determine z₁. When Z₁ is greater than 0.2078, obtain the performance metric R₂, and when z₁ is less than or equal to 0.2078, obtain the performance metric R₃. When x₁ is less than or equal to 0.357, determine Y₂. When Y₂ is greater than 0.7943, obtain the performance metric R₅, and when Y₂ is less than or equal to 0.7943, obtain the performance metric R₇. Further, when the object mean is less than or equal to 0.851, divide x₂ into a value range greater than 0.316 and a value range less than or equal to 0.316. When x₂ is greater than 0.316, determine Y₂. When Y₂ is greater than 0.1455, divide z₂ into a value range greater than 0.4582 and a value range less than or equal to 0.4582. When z₂ is greater than 0.4582, obtain the performance metric R₆, when z₂ is less than or equal to 0.4582, obtain the performance metric R₄, when y₁ is less than or equal to 0.1455, obtain the performance metric R₁, and when x₂ is less than or equal to 0.316, obtain the performance metric Rₘ.

Therefore, after step S4, the following step is further comprised: querying the prediction model based on the features of the input simulation task and the values of the parameter groups to obtain the values of the performance metrics. For example, in the embodiment of the grasping robot B, the customer enters the simulation task feature I and the parameter groups x, y and z. Therefore, when querying the decision tree shown in FIG. 6, the customer can obtain the values of corresponding performance metrics and the customer make a determination based on the prediction model.

In some embodiments, a prediction model learning apparatus for an industrial system performs a simulation for the industrial system according to a simulation task on a platform. In some embodiments, the prediction model learning apparatus for an industrial system comprises: a task feature management unit, configured to use statistical metrics to quantify a simulation task of the industrial system so as to extract features of the simulation task, a parameter adjustment management unit, configured to extract parameter groups from system modules of the industrial system which performs a simulation, adjust the values of the parameter groups, and trigger a simulation for the industrial system on the simulation platform based on a plurality of parameter groups having different values, a performance recording unit, configured to record performance metrics according to the values of the parameter groups after the parameter adjustment, a training data management unit, configured to train data by use of a machine learning algorithm based on the features of the simulation task, the corresponding parameter groups having different values and the performance metrics, and a learning management unit, configured to generate a prediction model.

In some embodiments, the parameter adjustment management unit further comprises a parameter feature group recording subunit, configured to extract parameter groups from system modules of the industrial system which performs a simulation, and mark adjustable parameter groups, a parameter adjustment subunit, configured to adjust the values of the adjustable parameter groups according to the corresponding adjustable range of each adjustable parameter group, and trigger a simulation for the industrial system on the simulation platform based on a plurality of parameter groups having different values; and a parameter recording subunit, configured to synchronize and record the combination and values of the parameter groups after the parameter adjustment.

In some embodiments, the performance recording unit further comprises a performance registration sub-unit, configured to record performance metrics according to the values of the parameter groups after the parameter adjustment, and a performance recording subunit, configured to record the values of the performance metrics based on the recorded performance metrics and the simulation result which correspond to each other.

In some embodiments, the performance metrics are key performance indexes or are determined based on the customer requirements.

In some embodiments, the learning management unit is configured to query the prediction model based on the features of the input simulation task and the values of the parameter groups to obtain the values of the performance metrics.

In some embodiments, a prediction model learning system for an industrial system comprises a processor and a memory coupled with the processor, the memory has instructions stored therein, the instructions allow the prediction model learning system for an industrial system to perform actions when executed by the processor, and the actions include: S1, using statistical metrics to quantify a simulation task of the industrial system so as to extract features of the simulation task; S2, extracting parameter groups from system modules of the industrial system which performs a simulation, adjusting the values of the parameter groups, and triggering a simulation for the industrial system on the simulation platform based on a plurality of parameter groups having different values; S3, recording performance metrics according to the values of the parameter groups after the parameter adjustment; S4, training data by use of a machine learning algorithm based on the features of the simulation task, the corresponding parameter groups having different values and the performance metrics, and generating a prediction model.

In some embodiments, action S2 further comprises: S21, extracting parameter groups from system modules of the industrial system which performs a simulation, and marking adjustable parameter groups; S22, adjusting the values of the adjustable parameter groups according to the corresponding adjustable range of each adjustable parameter group, and triggering a simulation for the industrial system on the simulation platform based on a plurality of parameter groups having different values; and S23, synchronizing and recording the combination and values of the parameter groups after the parameter adjustment.

In some embodiments, action S3 comprises: S31, recording performance metrics according to the values of the parameter groups after the parameter adjustment; and S32, recording the values of the performance metrics based on the recorded performance metrics and the simulation result which correspond to each other.

In some embodiments, the actions after action S4 include querying the prediction model based on the features of the input simulation task and the values of the parameter groups to obtain the values of the performance metrics.

In some embodiments, the present invention provides a computer program product tangibly stored in a computer-readable medium and comprises computer-executable instructions, and the computer-executable instructions allow at least one processor to execute one or more of the methods described herein when executed.

In some embodiments, a computer-readable medium stores computer-executable instructions allowing at least one processor to execute one or more of the methods described herein when executed.

Data in the simulation task is used to train and build a prediction model. In some embodiments, the step of adjusting parameters is a systematic and automatic step, allowing a simulation to produce a large amount of various parameters for data training. Parameter adjustments are often manually completed in the prior art, however. Therefore, those system parameters can be structurally explored and tested, avoiding incomplete considerations in manual parameter adjustment mode.

In some embodiments, simulation data can be converted into an online prediction model, which can direct a user to dynamically and more efficiently select a parameter combination and values for a complicated system. When a simulation is performed for an industrial system, the teachings herein may simultaneously help a customer to establish an online prediction system, allowing industrial customers to online predict the performance of their systems and dynamically adjust parameters.

Although the content of the present disclosure has been described in detail through the above-mentioned embodiments, the description above should not be considered as a restriction of the present disclosure. After those skilled in the art read the content above, various modifications and replacements are obvious to them. Therefore, the scope of protection of the present disclosure should be defined by the attached claims. In addition, any reference numeral in the claims should not be considered a restriction of the claims, the term “comprise” does not exclude other devices or steps not listed in the claims or the description, and the terms “first” and “second” are only used to represent a name, but not to represent any specific sequence.

What is claimed is:

1. A prediction model learning method for an industrial system, wherein a simulation is performed for the industrial system according to a simulation task on a platform, the method comprising:
using statistical metrics to quantify a simulation task of the industrial system so as to extract features of the simulation task;
extracting parameter groups from system modules of the industrial system which performs a simulation, adjusting the values of the parameter groups, and triggering a simulation for the industrial system on the simulation platform based on a plurality of parameter groups having different values;
recording performance metrics according to the values of the parameter groups after the parameter adjustment; and
training data by use of a machine learning algorithm based on the features of the simulation task, the corresponding parameter groups having different values and the performance metrics, and generating a prediction model.

2. The prediction model learning method for an industrial system as claimed in claim 1, wherein extracting parameter grooups from system modules of the industrial system which perfoms a simulation, adjusting thevalues of the parameter groups triggering a simulation for the industrial system on the simulation a for the industrial system on the simulation platform based on a plutality of parameter groups havng different values
extracting parameter groups from system modules of the industrial system which performs a simulation, and marking adjustable parameter groups;
adjusting the values of the adjustable parameter groups according to the corresponding adjustable range of each adjustable parameter group, and triggering a simulation for the industrial system on the simulation platform based on a plurality of parameter groups having different values; and
synchronizing and recording the combination and values of the parameter groups after the parameter adjustment.

3. The prediction model learning method for an industrial system as claimed in claim 1, wherein recording performance metrics according to the values of the parameter froups after the parameter adjustment includes:
recording performance metrics according to the values of the parameter groups after the parameter adjustment;and
recording the values of the performance metrics based on the recorded performance metrics and the simulation result which correspond to each other.

4. The prediction model learning method for an industrial system as claimed in claim 3, wherein:
the performance metrics comprise key performance indexes; or
the performance metrics are determined based on the customer requirements.

5. The prediction model learning method for an industrial system as claimed in claim 1, the method further comprises querying the prediction model based on the features of the input simulation task and the values of the parameter groups to obtain the values of the performance metrics.

6. The prediction model learning method for an industrial system as claimed in claim 5, wherein:
the industrial system comprises a context-aware robot;
the features of the simulation task include a plurality of metrics of a red-green-blue-depth (RGBD) image; and
the metrics include one or more of the following:
image resolution;
target scale in image; and
object mean.

7. The prediction model learning method for an industrial system as claimed in claim 6, wherein:
the context-aware robot comprises a grasping robot; and
system modules of the grasping robot include:
a vision module, configured to process an input RGBD image,
a path planning module, configured to figure out the path along which the manipulator moves to a grasping point according to the grasping point obtained through image recognition, and
an action control module, configured to control the movement of the manipulator according to the path planned by the path planning module.

8. A prediction model learning system for an industrial system, the system comprising:
a processor; and
a memory coupled to the processor, the memory having instructions stored therein, the instructions allowing the prediction model learning system for an industrial system to perform actions when executed by the processor;
wherein the actions include:
using statistical metrics to quantify a simulation task of the industrial system so as to extract features of the simulation task;
extracting parameter groups from system modules of the industrial system which performs a simulation, adjusting the values of the parameter groups, and triggering a simulation for the industrial system on the simulation platform based on a plurality of parameter groups having different values;
recording performance metrics according to the values of the parameter groups after the parameter adjustment;and
training data by use of a machine learning algorithm based on the features of the simulation task, the corresponding parameter groups having different values and the performance metrics, and generating a prediction model.

9. The prediction model learning system for an industrial system as claimed in claim 8, wherein eztracting parametr groups from groups from system modules of the industrial system which performs a of the industrial system which performs a simulation, adjusting the values of the parameter groups, and triggering a simulation for the industrial system on the simulation platform based on a plurality of parametergroups having different valuesfurther comprises:
extracting parameter groups from system modules of the industrial system which performs a simulation, and marking adjustable parameter groups;
adjusting the values of the adjustable parameter groups according to the corresponding adjustable range of each adjustable parameter group, and triggering a simulation for the industrial system on the simulation platform based on a plurality of parameter groups having different values; and
synchronizing and recording the combination and values of the parameter groups after the parameter adjustment.

10. The prediction model learning system for an industrial system as claimed in claim 8, wherein recording performance metrics according to the values of the parameter groups after the parameter adjustment comprises:
recording performance metrics according to the values of the parameter groups after the parameter adjustment; and
recording the values of the performance metrics based on the recorded performance metrics and the simulation result which correspond to each other.

11. The prediction model learning system for an industrial system as claimed in claim 8, further comprising querying the prediction model based on the features of the input simulation task and the values of the parameter groups to obtain the values of the performance metrics.

12. A non-transitory computer-readable medium, storing computer-executable instructions allowing a processor to execute prediction model learning method for an industrial system, wherein a simulations is performed for the industrial system according to a simulation task on a platform, the method comprising:
using statistical metrics to quantify a simulation task of industrial system so as to extract features of the simulation the industrial system fo as to extract features of the simulation task;
extracting parameter groups from system modules of the industrial system which performs a smimulation, adjusting the values of the parameter groups, and triggering a simulation for the industrial system on the simulation platform based on a pluralty of parameter groups having differnt values;
recoding performance metrics according to the values of the parameter groups afer the parameter adjustment; and
training by us of a machine learning algorithm based on the features of the simulation task, the corresponding parameter groups having different values adn the perfomance metrics, and generating a prediction model.

13. A prediction model learning apparatus for an industrial system, the apparatus comprising:
a task feature management unit configured to use statistical metrics to quantify a simulation task of the industrial system so as to extract features of the simulation task;
a parameter adjustment management unit configured to extract parameter groups from system modules of the industrial system which performs a simulation, adjust the values of the parameter groups, and trigger a simulation for the industrial system on the simulation platform based on a plurality of parameter groups having different values;
a performance recording unit configured to record performance metrics according to the values of the parameter groups after the parameter adjustment;
a training data management unit configured to train data by use of a machine learning algorithm based on the features of the simulation task,wherein the corresponding parameter groups have different values and the performance metrics; and
a learning management unit configured to generate a prediction model.

14. The prediction model learning apparatus for an industrial system as claimed in claim 13, wherein the parameter adjustment management unit further comprises:
a parameter feature group recording subunit configured to extract parameter groups from system modules of the industrial system which performs a simulation and mark adjustable parameter groups;
a parameter adjustment subunit configured to adjust the values of the adjustable parameter groups according to the corresponding adjustable range of each adjustable parameter group and trigger a simulation for the industrial system on the simulation platform based on a plurality of parameter groups having different values; and
a parameter recording subunit configured to synchronize and record the combination and values of the parameter groups after the parameter adjustment.

15. The prediction model learning apparatus for an industrial system as claimed in claim 13, wherein the performance recording unit further comprises:
a performance registration sub-unit configured to record performance metrics according to the values of the parameter groups after the parameter adjustment; and
a performance recording subunit configured to record the values of the performance metrics based on the recorded performance metrics and the simulation result which correspond to each other.

16. The prediction model learning apparatus for an industrial system as claimed in claim 15, wherein comprise wherein the performance metrics comprise key performance indexes or are determined based on the customer requirements.

17. The prediction model learning apparatus for an industrial system as claimed in claim 13, wherein the learning management unit is configured to query the prediction model based on the features of the input simulation task and the values of the parameter groups to obtain the values of the performance metrics.

18. (canceled)
